(19) United States
(12) Patent Application Publication
(10) Pub. No.: US 2025/0015991 A1
(43) Pub. Date: Jan. 9, 2025

(54) MECHANISMS AND METHODS FOR THE MANAGEMENT OF DEVELOPMENT ENVIRONMENTS WITH DATA SECURITY

(71) Applicant: strong.network SA, Lausanne (CH)

(72) Inventors: Laurent Balmelli, St-Blaise (CH); Ozrenko Dragic, Lausanne (CH); Fernando Monje Real, Lausanne (CH); Bjorn Gudmundsson, Lausanne (CH); Bastian Nanchen, Lausanne (CH); Torstein Meyer, Lausanne (CH); Marko Djokic, Zemun (RS)

(73) Assignee: strong.network SA, Lausanne (CH)

(21) Appl. No.: 18/765,177

(22) Filed: Jul. 5, 2024

Related U.S. Application Data
(60) Provisional application No. 63/525,542, filed on Jul. 7, 2023.

(51) Int. Cl. H04L 9/14; G06F 9/455

(52) U.S. Cl. CPC H04L 9/14; G06F 9/45558; G06F 2009/45587; G06F 2009/45595

(57) ABSTRACT

A platform to manage a series of software containers and virtual machines for integrated software development that allows control over data that is exfiltrated or infiltrated through a series of mechanism and network protocols connecting to the container's content, accessible over a network by an authenticated software developer, each software container and virtual machine being associated to a credentials management unit having access to a database of credentials that are not known to the software developer, the credentials management unit being configured to monitor network traffic, detect an authentication process to an external resource in the network traffic, present to the external resource a corresponding credential selected from the database, where data exchange can happen in a purely protocol-based fashion without human intervention via a secure browser to allow control even when human interaction is needed.

### TECHNICAL FIELD

The present invention relates to a distributed, network-accessible platform for the development of software products and methods for developing computer code on the platform with security.

### RELATED ART

Software development is a major industry encompassing the industrial and commercial activities dedicated to the creation, design, deployment, evolution, and support of computer software products. Software development increasingly relies on networked resources and virtual resources to facilitate distributed development, meet changing user needs and dynamically allocate development tasks.

Security in a distributed software development environment presents unique challenges. In general, any transfer of information in and out of the development platform is a potential source of risk; however, developers need to consult external sources and cannot work effectively in a completely isolated environment. Traditionally, security has been enforced by providing the developers with vetted laptops that run security software that is designed to block any unauthorised exfiltration of proprietary information and infiltration of undesirable or potentially harmful information. Such vetted laptops must be especially developed. They need to be maintained and updated remotely which is an additional burden.

Operating systems provide common mechanisms for transferring data between applications, the best known of which is the ubiquitous clipboard where data is stored between copy and paste operations. In conventional data development systems this mechanism could be exploited to extract data from or insert data in the protected workspace without authorisation.

Virtualization is a constellation of techniques that build an abstraction layer above a physical computing hardware. Virtual machines simulate a physical computer in software form and run an entire operating system with a plurality of system processes and user processes.

Containers represent another form of virtualisation: containers are executable units of software that combine an application code along with the libraries and dependencies needed to run the code, into a standardised package that runs consistently across different infrastructures and different computing environments. Multiple containers can share the host system's kernel and resources at the same time; however, each container runs in its own isolated environment. This isolation prevents conflicts and increases security.

With respect to virtual machines, containers are less resource intensive and more agile because they do not require virtualisation of the underlying hardware

### Short Disclosure of the Invention

An aim of the present invention is to provide a system and a method which overcomes the shortcomings and limitations of the state of the art.

According to the invention, the invention relates to a software container for integrated software development, accessible over a network by an authenticated software developer, the software container being associated with a credentials management unit acting as proxy, having access to a database of credentials that are not known to the software developer, the credential management unit being configured to monitor network traffic, detect an authentication process to an external resource in the network traffic, present to the external resource a corresponding credential selected from the database.

Dependent claims introduce further technical features and limitations which, while being useful or important, are not essential to the invention. These include the fact that the software container can run secure Internet-enabled apps capable of accessing the internet on predetermined TCP ports. The developer can interact with the secure apps through a SSH connection and/or a HTTPS connection. For example, the container may enable a web-based interactive development environment with whom the developer can interact through the developer's HTTPS connection.

Importantly, embodiments of the invention include a traffic interception unit that is configured to detect traffic directed to external internet resources, blocking or allowing it based on the identity of the addressed resource and also on content. In a remarkable use case, the secure platform of the invention allows the access to a web-based AI-assistant, provided it belongs in a whitelist of approved resources, in a controlled fashion, detecting several kinds of sensitive information in the prompt, and granting or forbidding access accordingly. The secure platform may also include a secure AI-assistant.

Secure apps may comprise also a secure web browser configured to establish secure HTTPS connexions with internet-based services, render a secure HTTPS connexion to a local monitor of the software developer and allow the developer to interact with a server at a remote end of the secure HTTPS connexion using his local mouse and keyboard, through the developer's HTTPS connexion. Preferably, the secure browser is configured to forbid download operations in general, or to forbid download operation from selected blacklisted URIs, or to allow download operations from selected whitelisted URIs exclusively; furthermore, the secure browser may control the clipboard content and prevent pasting of data outside of the software container.

Embodiments of the invention relates as well to a web-based platform for the development of software products, configured to host a plurality of the software containers as detailed above. The credentials management is hosted by the platform and oversees connections over a series of network protocols such as HTTP, HTTPS, SSH, TCP, UDP, Git and others of a plurality of software containers.

The invention also includes variants that provide virtual machines as well as containers, for example for the development of drivers or low-level OS components. The following disclosure will refer to containers mostly, for concision sake, but it should be understood that the invention encompasses virtual machines as well.

### SHORT DESCRIPTION OF THE DRAWINGS

Exemplar embodiments of the invention are disclosed in the description and illustrated by the drawings in which:

FIG. 1 illustrates schematically an overview of the inventive system

FIG. 2 shows a software interface element that is configured to manage network access policies.

FIG. 3 shows a software interface element that is configured to manage the access to external resources.

FIG. 4 shows schematically a mechanism of remediation against exfiltration of data

FIG. 5 shows schematically the role of a credentials manager in the inventive system, with a secure browser hosted by the same secure platform.

FIG. 6 shows possible exfiltration paths abusing the clipboard mechanism.

FIG. 7 shows a software interface configured to restrict or record clipboard uses.

FIG. 8 shows a software interface configured to control the use of an external generative-AI assistant.

### EXAMPLES OF EMBODIMENTS OF THE PRESENT INVENTION

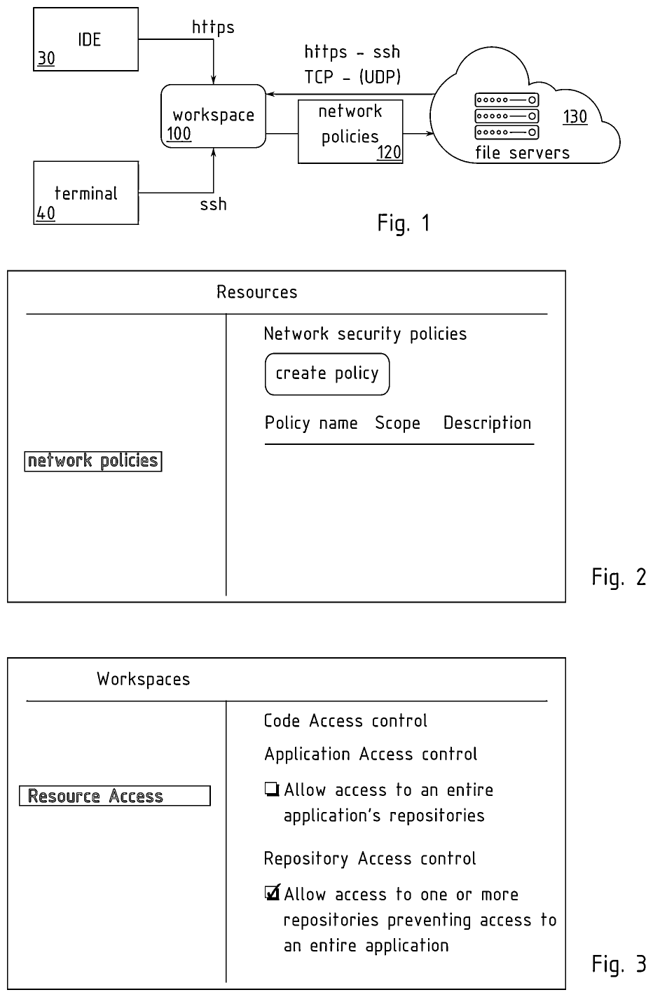

FIG. 1 schematically illustrates, in a very idealised way, a code development platform that can be deployed on the Internet to allow concurrent development of a software project in a secure manner. The developers in charge of a part of the project work through a secure virtual workspace 100, which is actually implemented by a collection of software elements running in a software container, such as a Linux container.

Although the figure shows one workspace, it is understood that the platform can serve many concurrent workspaces.

The workspace container 100 can run applications that can access the internet and can be accessed, for example, on predetermined TCP ports. These applications are referred to as ‘workspace apps’ or ‘workspace applications’.

Developers may access the workspace 100, or rather the workspace apps running therein, by a terminal interface 40 communicating via a suitable internet protocol, for example SSH. The authentication of the developer and the encryption of the communication stream could be achieved by the presentation of a signed certificate, or in any other suitable manner.

Another way of interacting with the workspace 100 may be a web-based interactive development environment (IDE) 30 that accesses the workspace 100 through a suitable protocol.

Importantly, the workspace 100 provides connectivity to third party cloud-based web applications that are important for the development workflows. This includes for example submitting pull requests to a git-based repository, such as ‘github’, ‘gitlab’, ‘bitbucket’ or any other similar service, or accessing online documentation and support.

From the security perspective, the IDE, terminal, clipboard and workspace connectivity, e.g. SSH connection and network capabilities are mechanisms that can be used for data exfiltration (unauthorised copying of project data to an external party) or infiltration (unauthorised insertion of external data into the project). These mechanisms are explained in the following scenarios describing possible security breaches and their remediation. For completeness, the security model around secure apps will be disclosed in the last scenario, with the understanding that it is also applicable elsewhere.

### From a Workspace to an External Server

This scenario relies on the general connectivity of the workspace. The developer has access to the workspace from the terminal, connected to IDE, and can attempt to exfiltrate files to a server that they control. Files can be transferred using HTTPS, SSH, FTP, or any TCP-based protocol. Using code or a terminal (shell) command.

The remedy for this breach lies in a set of configurable network policies (shown as a block 120 in FIG. 1) that allow a complete control of the traffic out of the workspace to the internet. The inventive system provides at least three types of network policies: monitored, restricted, and inspected. The network policies oversee all TCP protocols. UDP traffic is blocked, with the sole exception of DNS.
A monitored network policy allows the outbound traffic and logs a trace of the outbound traffic in a log.
A restricted network policy only allows traffic to whitelisted resources, for example defined by a set of domains or URIs, and also logs this traffic as in the monitored policy. Traffic towards unknown (non-whitelisted) domains is blocked.
An inspected network policy allows only traffic to whitelisted resources and this traffic is inspected using a man-in-the-middle approach and logged as in the above policies.

A remarkable use case attached to the inspection of network traffic is the control of data execution using an external generative-AI assistant.
Systems like, for example, GitHub Copilot, draw context from an existing codebase to suggest fragments of code, or entire functions, in answer to prompts generated by the environment. This is a potential path to exfiltration or infiltration of sensitive data through a network connection.

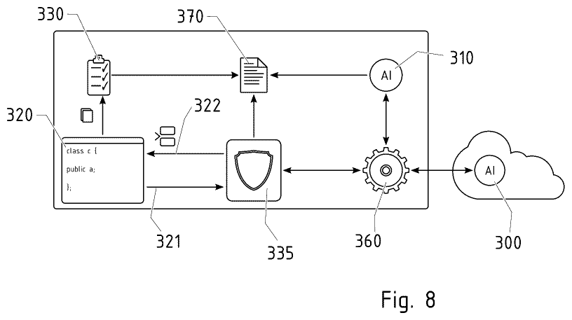

As illustrated by FIG. 8, the external resources may include a generative-AI code assistant 300. Block 320 represents an interactive development environment, or simply a terminal, that is used to develop or maintain a code product. In the process, the developer desires to obtain the assistance of an AI code assistant. Traditionally, this is achieved by transmitting to the assistant (arrow 321) a suitable prompt that provides some necessary context to the code being developed in the IDE and receiving a snippet of code or a whole function in return (arrow 322). Block 335 intercepts the traffic directed to the network and, seeing that it is addressed to a whitelisted resource (the assistant 300), records the exchange in the log 310 and passes the information to the rule engine 360 that checks for the presence of sensitive information like:
credentials embedded in the code that could be used to access a system that holds organization data,
information about the internal infrastructure of the organization that an attacker may be able to understand and use maliciously,
any information with intellectual property value.

Based on the application of the predetermined rules in the rule engine, the prompt can be transmitted to the desired external AI-assistant 300, to an alternative safe assistant 310 that is preferably hosted by the same safe infrastructure, or by another secure infrastructure, or blocked.

In addition to checking the prompt for exfiltration, the rule engine 360 is also configured to check the reply of the external assistant 300 to identify and block potential infiltration of undesirable data. Preferably, the information originating internally as well as generated externally is tagged specially, and may incur additional security controls later on, by an artificial controller or a human one. Tags allow the use of a rule engine to decide on the way the generated information should be processed.

The IDE and the terminal have a data loss protection mechanism that monitors the clipboard and prevents the insertion (pasting) data outside of the scope of the IDE, terminal and secure apps.

FIG. 2 shows, in idealised form, a software interface element that allows a manager or a qualified user to configure network access policies in the secure platform of the invention. This management tool allows to define for each policy a scope to which the policy applies, such as a specific project or projects, or a set of users working in one or several project, a security group collecting several users, and so on), a type of the policy (monitored/restricted/inspected) that determines its behaviour, a set of whitelisted resources, and any other needed parameter.

### From a Workspace to Connected Services

The platform supports external resources that use any TCP-based network protocol, for example HTTP/HTTPS/SSH services, and are associated with particular workspaces for performing the development task at hand. These resources are referred to as connected services in the platform and are used, importantly, to access cloud-based software development and version control systems, such as ones based on the Git protocol, but may also have other uses.

Traffic in and out of connected services is fully governed by the platform access control and credential management mechanisms. Only explicitly authorised workspaces can be accessed to retrieve (pull) or upload (push) data. In addition, all traffic to the service is fully recorded in the audit log and can be traced back in the workspace. In addition, the IDE and the workspace have a data loss protection mechanism that monitors the clipboard and prevents data from being pasted outside the scope of the IDE, terminal and secure apps.

FIG. 3 shows, in an idealised manner, a software interface element which allows a manager or a qualified user to configure connected services in the secure platform of the invention. This management tool allows the definition of the behaviour for each service.

### Between a Workspace and a Local Device

In this scenario a user may attempt to leverage the ability of an online IDE (e.g. Visual Studio code, IntelliJ, PyCharm, etc.) to download files locally from the project to the local device storage. In the other direction, many IDEs allow for upload operations, for example dragging a file icon onto the active window of the IDE.

The administrator of the platform can completely disable the download feature of all the supported IDEs. When this setting is active, it is not possible to download a file from the workspace to the local device. In the upload direction, the transfer can be prohibited or, if desired, a scan of the file can be enforced before the operation is allowed. The scan is represented by block 160 in FIG. 4. It can be performed on the platform, or by a third-party cloud-based scanning service 150. All download or upload operations are automatically logged.

### Connecting to a Workspace Using an SSH Connection

In this scenario the workspace is accessed via an SSH connection originating from outside the platform. Once a connection is established, the ability to download files depends on an application running on the local computer, such as a local IDE application of a terminal emulator.

As the platform has no control over what the client does, this configuration provides little security against data exfiltration or infiltration. Therefore, SSH access can be disabled by an administrator or a qualified user. This rule can be enforced globally, for all workspaces without exceptions, for some workspaces, or for some users.

### Running Applications on the Workspace

As mentioned above, the user can cause applications to run in the workspace, with network connectivity. For example, it is possible to run an instance of a web application under development. Running such an application provides an opportunity to exfiltrate data by connecting to the port used by the application with a browser, for example.

To mitigate this scenario, the workspace can be set up so that applications running in the workspace will run as secure apps, i.e. only accessed via a secure browser. Secure apps and secure browsers will be defined in the next scenario.

### Accessing Third Party Web Applications Via a Secure App

The platform can connect to web applications via a version of a navigator (for example Google Chrome) that allows the application to be remotely rendered in the browser. The user can access and provide input to the application to perform the intended tasks using their local mouse and keyboard.

Secure apps, in the context of this disclosure, are applications that have access only to a set of whitelisted network resources, such as network domains and do not have arbitrary access to the Internet. Thus, user operations are restricted to the domain for which the secure application has been configured. In addition:
Any click operation on the application is logged by the platform.
Operations on the web application can be disabled by blacklisting some of the links.
Download operations can be disabled on the secure browser.
Finally, the secure browser has full control on the clipboard content and prevents pasting data outside of the scope of the secure browser, effectively preventing data exfiltration.

This part of the platform allows the authenticated developers to interact directly with external web applications in a natural and secure way. For example, a developer could register a pull request in a git-based software repository that allows it using the web interface that they are used to, with the security provided by the secure browser.

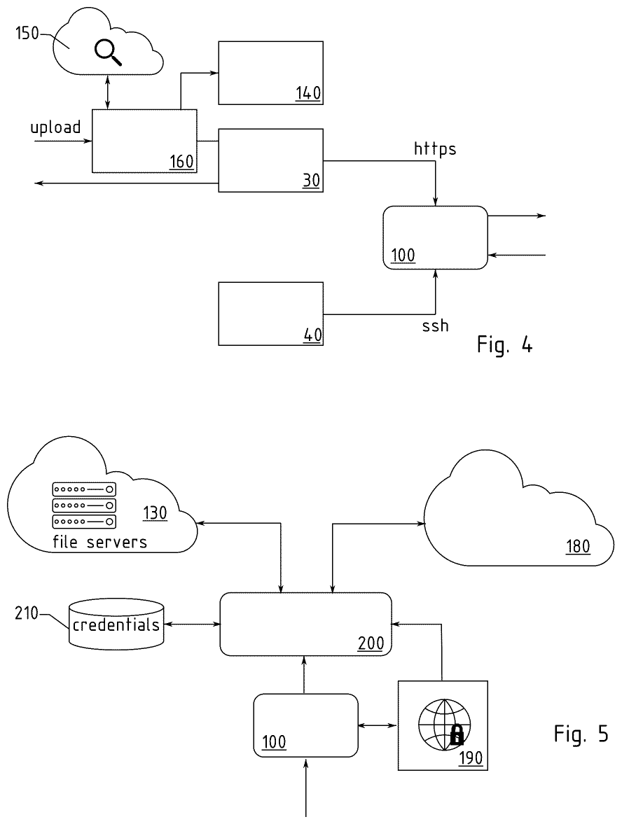

Preferably, the invention includes a mechanism for managing the access to external file repositories without exposing the necessary credentials. FIG. 5 illustrates a process in which an authenticated developer working from a containerized workspace 100 logs in a cloud-based external file server 130 that hosts a repository for a software project. The external server could be gitHub, gitLab, or any other suitable platform.

The developer opens an https session with the service 130 through a secure web browser 190 that is hosted by the same platform as the container 100, as disclosed above. A credential management unit in the platform acts as proxy and intercepts the session traffic and presents the required credentials to the service allowing the session to connect successfully. Importantly, the credentials are not disclosed to the developer, thereby preventing any attempt to connect to the same repository from an external client. The unit 200 may oversee the sessions of many developers, attending to different software projects, possibly needing diverse cloud services 130, 180. Preferably, the credential management unit 200 can retrieve the credentials needed to connect to the corresponding repositories from a database 210.

The credential management is preferably configured to manage user-centric digital identities based on any suitable authentication method,
e.g. public-private key pairs, such that the user can authenticate to any network service supporting the authentication method via the credential management unit. The authentication may use HTTPS, Git, SSH, or any TCP/UDP based protocol as specified by the network services. The digital identities that the developers use to connect to the network services can be generated in the credential manager on request, and associated with a specific user, or provided by the user.

Preferably, the system of the invention is equipped with a mechanism to define any network services, e.g. Git applications, Git repositories, HTTP, SSH and TCP-based services, container registries, or any authenticated services connected to the platform whose authentication mechanism uses the credential management unit. This may consist of a list of reachable services specified as domain names, IP addresses.

### Preventing Data Exfiltration, Disclosed Exfiltration and Infiltration Through Short Term Transfer Storage

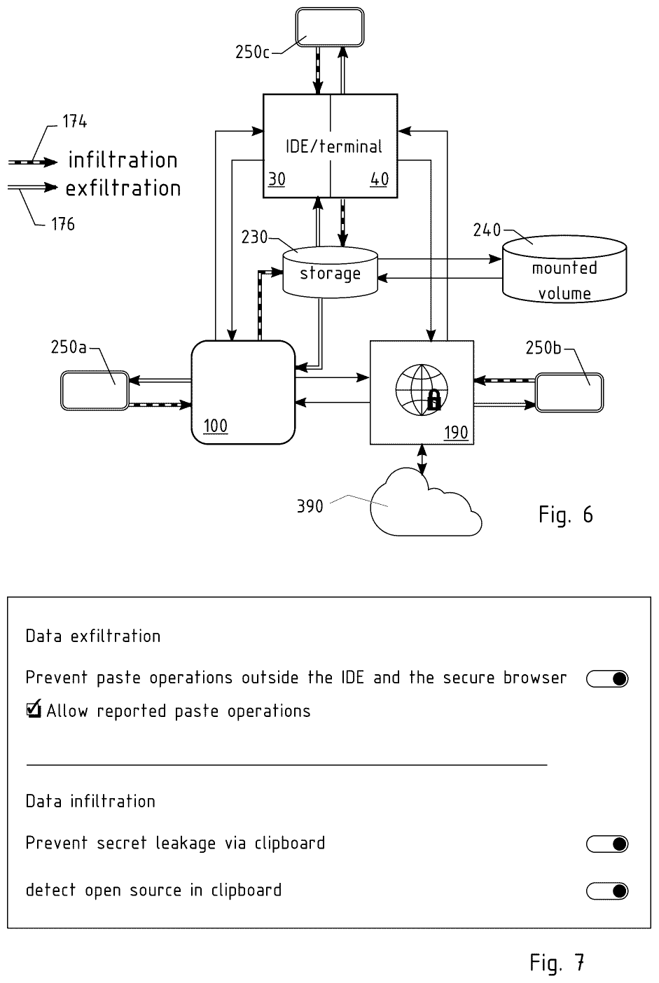

FIG. 6 illustrates possible paths of exfiltration and infiltration of data via the clipboard or a similar mechanism. The protected workspace 100, the secure browser 190 that communicates with the internet 390, the terminal 40 and the integrated development environment 30 allow copy/paste operations (boxes 250a, and respectively 250b and 250c). Thick dashed arrows 174 and double-line arrows 176 represent possible infiltration/exfiltration paths that abuse the clipboard.

The platform of the invention provides a protection against this form of data loss for applications that are onboarded on the platform 100 and accessed via the secure browser 190 are protected against this form of data loss; however, the secure browser is not as fast and responsive as a normal browser and not all the applications that could be legitimately used are available in this manner. An example, among many others, would be a user wishing to share a piece of information found in the platform on Slack or another similar collaborative platform accessible through a conventional browser.

To provide this flexibility, the platform may provide an interface to request a permission to paste information outside the authorized scope defined by the applications running on the platform (the IDE and the applications running in the secure browser). The user shall preferably disclose the data that are to be pasted outside the scope, and the platform will grant or deny the permission based on the data content. In practice the GUI will show a special clickable icon that will be used to request the authorization to paste a content out of the normally authorised scope.

Preferably, the authorisation request will trigger a series of operations as defined by the organisation's information security policy. For example, the user may be required to specify which tool they wish to paste his information. There could be automatic blocks for example if a token has been detected in the clipboard, or if the content of the clipboard exceeds a certain size. The platform will also provide an interface through which an administrator can specify such security policies, as shown in the example of FIG. 7.

Secure platform 100 includes an automatic classifier that analyses the content of the clipboard and determines its semantic nature in order to decide the policy to apply. These include among others: identifiers (passwords, userid, security certificates and so on), source code, open-source code, personally identifiable information, or any information stored in a specially appointed database of sensitive information. The classifier can be hosted on the same infrastructure that supports the secure platform 100 or on a separate infrastructure. It could be cloud-based and may use AI technology to determine whether any given block of data comprises sensitive information.

The classifier may operate on the clipboard contents that are disclosed by the user as explained above, or on the clipboard contents of the secure browser and decide whether they include sensitive information. The semantic nature of the clipboard content is dependent on whether the user operation is deemed as an exfiltration, i.e. the data originated from the IDE, terminal or secure app, or an infiltration, i.e. the data originated from outside the IDE, terminal or secure apps. This decision may be a hard one (a true/false value) or a soft one (an estimate of a probability). Based on this decision the copy/paste operations are allowed or denied.

### REFERENCE SYMBOLS IN THE FIGURES

30 IDE
40 terminal
100 containerised workspace
120 network policies
130 cloud service
150 third-party scanning engine
160 scanning service
174 infiltration
176 exfiltration
180 cloud service
190 secure web browser
200 proxy, credentials management
210 credentials database
230 storage
240 mounted volume
250 copy/paste
250a copy/paste from/to workspace app 250b copy/paste from/to secure web app 250c copy/paste from/to IDE or terminal
300 external web-hosted AI assistant
320 IDE
321 prompt
322 returned code
330 clipboard
370 log
310 internal AI assistant
360 rule engine
335 traffic interception
390 internet or WAN

1. A software container or a virtual machine for integrated software development, accessible over a network by an authenticated software developer, the software container or virtual machine being associated to a credentials management unit having access to a database of credentials that are not known to the software developer, the credentials management unit being configured to monitor network traffic, detect an authentication process to an external resource in the network traffic, present to the external resource a corresponding credential selected from the database.

2. The software container or virtual machine of claim 1 equipped with a mechanism to manage user-centric digital identities based on any authentication method, e.g. public-private key pairs, such that the user can authenticate to any service supporting the authentication method via the credential management unit.

3. The software container or virtual machine of claim 1 equipped with a mechanism to manage the digital identities for each user to authenticate with the various network services via their specific protocols such as HTTPS, Git, or any TCP/UDP based protocol using the credential management unit.

4. The software container or virtual machine of claim 1 equipped with a mechanism to store digital identities to use across various services and users, and as well user-centric digital identities, e.g. assigned to particular users, where identities are either auto-generated or provided by users to authenticate to services as explained in claim 3.

5. The software container or virtual machine of claim 1 equipped with a mechanism to define any network services, e.g. Git applications, Git repositories, HTTP, SSH and TCP-based services, container registries, or any authenticated services connected to the platform whose authentication mechanism uses the credential management unit.

6. The software container or virtual machine of claim 1 equipped with a mechanism to specify allowed network traffic consisting of a list of reachable services specified as domain names, IP addresses.

7. The software container or virtual machine of claim 1, configured to run applications capable of accessing the internet on predetermined TCP ports, comprising a unit configured to intercept internet traffic and detect and prevent exfiltration of sensitive data.

8. The software container or virtual machine of claim 7, hosting a web-based interactive development environment with whom the developer can interact through the developer's HTTPS connection.

9. The software container or virtual machine of claim 7, wherein the applications include a secure web browser configured to establish secure HTTPS connexions with internet-based services, render a secure HTTPS connexion to a local monitor of the software developer and allow the developer to interact with a server at a remote end of the secure HTTPS connexion using his local mouse and keyboard, through the developer's HTTPS connexion.

10. The software container or virtual machine of claim 9, wherein the secure browser is configured to forbid download operations in general, or to forbid download operation from selected blacklisted URIs, or to allow download operation from selected whitelisted URIs exclusively,

11. The software container or virtual machine of claim 9, wherein the secure browser controls the clipboard content and prevents, or conditionally prevents, pasting of data outside of the scope of the IDE, terminal or secure apps.

12. Network-based platform for the development of software products, configured to host a plurality of the software containers or virtual machines of claim 1.

13. The network-based platform of claim 12, wherein the credentials management is hosted by the platform and oversees to the secure HTTPS connection of a plurality of software containers.

14. A network-based platform for integrated software development, accessible over a network by an authenticated software developer, configured to run a secure web browser configured to establish secure HTTPS connexions with internet-based services, render a secure HTTPS connexion to a local monitor of the software developer and allow the developer to interact with a server at a remote end of the secure HTTPS connexion using his local mouse and keyboard, through the developer's HTTPS connexion.

15. The network-based platform of claim 14, packaged in a software container or in a virtual machine.

16. The network-based platform of claim 14, wherein the secure browser is configured to control the clipboard content and prevent, or conditionally prevent, pasting of data outside of the scope of the IDE, terminal and secure apps.

17. The network-based platform of claim 14, comprising a classifier configured to analyse the content of the clipboard and determine whether the content of the clipboard includes licensed code, access credentials, or sensitive information based on a semantic analysis, wherein the secure browser is configured to control the clipboard content and prevents pasting of data outside of the scope of the IDE, terminal and secure apps unless the clipboard content is submitted by the developer to the classifier and the classifier determines that they do not include sensitive information.

18. The network-based platform of claim 17, wherein the classifier is configured to detect semantically significant data and reserved data including one or more of: code development information, data science, business data, source code, open-source code, personally identifiable dana, malware, access credentials, information stored in a database of sensitive information.

19. A method of software development comprising the provision of a software container or of a virtual machine accessible over a network by an authenticated software developer, and comprising software development tools the software container or virtual machine being associated to a credentials management unit having access to a database of credentials that are not known to the software developer, the credentials management unit being configured to monitor network traffic, detect an authentication process to an external resource in the network traffic, present to the external resource a corresponding credential selected from the database.

20. The method of claim 19, wherein the software container or virtual machine is configured to run applications capable of accessing the internet on predetermined TCP ports, wherein the software developer can interact with the applications through a SSH connection and/or a developer's HTTPS connection.

21. The method of claim 20, the software container or virtual machine hosting a web-based interactive development environment with whom the developer can interact through the developer's HTTPS connection.

22. The method of claim 20, wherein the applications include a secure web browser configured to establish secure HTTPS connexions with internet-based services, render a secure HTTPS connexion to a local monitor of the software developer and allow the developer to interact with a server at a remote end of the secure HTTPS connexion using his local mouse and keyboard, through the developer's HTTPS connexion.

23. The method of claim 22, wherein the secure browser is configured to forbid download operations in general, or to forbid download operation from selected blacklisted URIs, or to allow download operation from selected whitelisted URIs exclusively,

24. A method of software development comprising the provision of a network-based platform for integrated software development, accessible over a network by an authenticated software developer, the platform being configured to run a secure web browser configured to establish secure HTTPS connexions with internet-based services, render a secure HTTPS connexion to a local monitor of the software developer and allow the developer to interact with a server at a remote end of the secure HTTPS connexion using his local mouse and keyboard, through the developer's HTTPS connexion.

25. The method of claim 24, packaged in a software container or in a virtual machine.

26. The method of claim 19, wherein the secure browser is configured to control the clipboard content and prevents pasting of data outside of the software container.

27. The method of claim 19, comprising a classifier configured to analyse the content of the clipboard and determine whether the content of the clipboard includes sensitive information, wherein the secure browser is configured to control the clipboard content and prevents pasting of data outside of the scope of the IDE, terminal and secure apps unless the clipboard content is submitted by the developer to the classifier and the classifier determines that they do not include sensitive information.

28. The method of claim 22, wherein the classifier is configured to detect semantically significant data and reserved data including one or more of: code development information, data science, business data, source code, open-source code, personally identifiable dana, malware, access credentials, information stored in a database of sensitive information.
